(19) United States
(12) Patent Application Publication
(10) Pub. No.: US 2009/0228357 A1
(43) Pub. Date: Sep. 10, 2009

(54) Method and System for Displaying Relevant Commercial Content to a User

(76) Inventor: Bhavin Turakhia, Malad (West) (IN)

Correspondence Address: Daniel M. Gurfinkel;Welsh & Katz, Ltd., 120 S. Riverside Plaza, Chicago, IL, 60606, US

(21) Appl. No.: 12/106,016

(22) Filed: Apr. 18, 2008

(30) Foreign Application Priority Data
Mar. 5, 2008 (IN) 458/MUM2008

(51) Int. Cl. G06Q 30/00; G06F 3/048; H04L 9/32

(52) U.S. Cl. 705/14; 715/738; 726/5; 726/6

(57) ABSTRACT

The present invention relates to a system and method for displaying commercial content within or alongside an application on a computing device, based on a user's browsing history. The commercial content can be displayed within or alongside an offline application, for example, when the computing device is offline, or on an online application such as a browser.

### FIELD OF THE INVENTION

The invention relates generally to method and system for displaying commercial content on a computing device, and specifically to displaying commercial content within or alongside an application on the computing device, based on a user's browsing history.

### BACKGROUND OF THE INVENTION

Internet has become a favorable medium for advertising due to its rising popularity. Typically, service providers provide advertisers with a platform to advertise online. Existing technologies allow a service provider to collect vast amounts of data from users based on various techniques such as determining the user's IP address, fetching cookies from the user's computing device etc. The service provider can then display the most relevant commercial content to a user based on the collected information.

Delivering targeted commercial content to users is a top priority for the service providers, since targeted commercial content has proved to be extremely useful and profitable. Display of targeted commercial content, based on the user behavior on the Internet, increases the likelihood of a user getting commercial content exactly based on his requirements leading to higher conversions for the advertisers.

Hence, there is a need to provide method and system for displaying commercial content relevant to a user directly in one or more application on the user's computing device.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

FIG. 1 illustrates a block diagram of an exemplary environment for displaying commercial content within or alongside an application on a computing device, in accordance with various embodiments of the present invention.

FIG. 2 illustrates a flow diagram of a method for displaying the commercial content within or alongside the application on the computing device, in accordance with an embodiment of the present invention.

FIG. 3 illustrates a flow diagram of a method for displaying the commercial content within a website page being browsed by a user on the computing device, in accordance with an embodiment of the present invention.

FIG. 4 illustrates a block diagram of a system for displaying the commercial content within or alongside the application on the computing device, in accordance with an embodiment of the present invention.

FIG. 5 illustrates a block diagram for displaying the commercial content within the website page being browsed by the user on the computing device, in accordance with an embodiment of the present invention.

### DETAILED DESCRIPTION OF THE INVENTION

Before describing in detail embodiments that are in accordance with the invention, it should be observed that the embodiments reside primarily in combinations of method steps and apparatus components related to displaying commercial content within or alongside an application on a computing device. Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of displaying the commercial content within or alongside the application on the computing device described herein. The non-processor circuits may include, but are not limited to, a radio receiver, a radio transmitter, signal drivers, clock circuits, power source circuits, and user input devices. As such, these functions may be interpreted as steps of a method and system for displaying the commercial content within or alongside the application on the computing device. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention relates generally to displaying the commercial content, relevant to the user, within or alongside the application on the computing device. Those skilled in the art shall appreciate that commercial content can be any content that can either have a commercial value such as advertising content, or content that may lead a user to purchase a product or service or even content that can merely be informational in nature such as the weather of a city or stock quotes for the day or restaurants in places the user intends to visit or any such information. Further, those skilled in the art shall also appreciate that the application on which the commercial content is displayed can be an offline application, such as a media player, games etc. or web applications such as email systems, webpages, chat programs etc. Essentially, the application can be any application on the computing device or an application served on the computing device through a browser, which may enable the display of the commercial content. For instance, the commercial content such as advertisements, weather metadata information, stock quotes etc. can be displayed to a user browsing webpages using a browser. Alternatively, a chat client may use a plugin to display commercial content to users of the chat client. Hence, the scope of the present invention may extend to any and all applications on the computing device. Also, the commercial content can be displayed within the application, for instance, within a chat window or within the browser, or the commercial content can be displayed outside the application, for instance, in a view pane alongside the chat client or the browser.

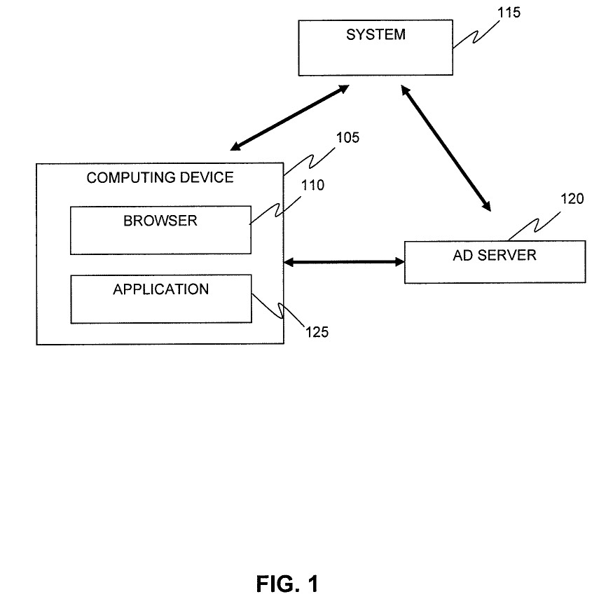

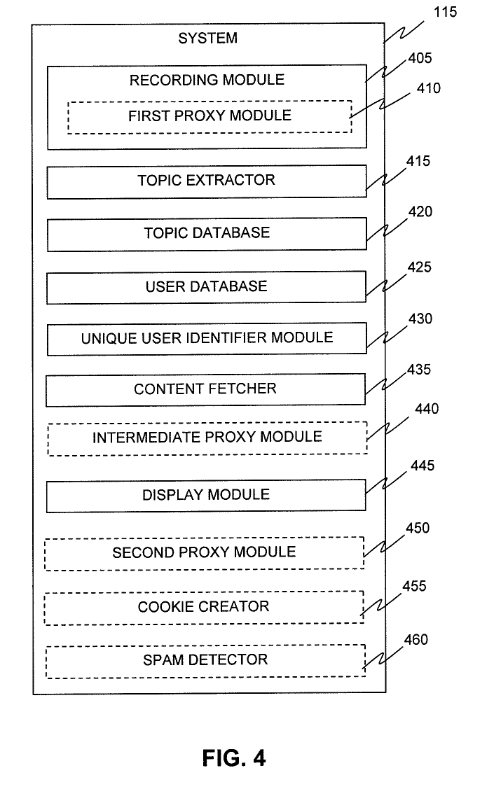

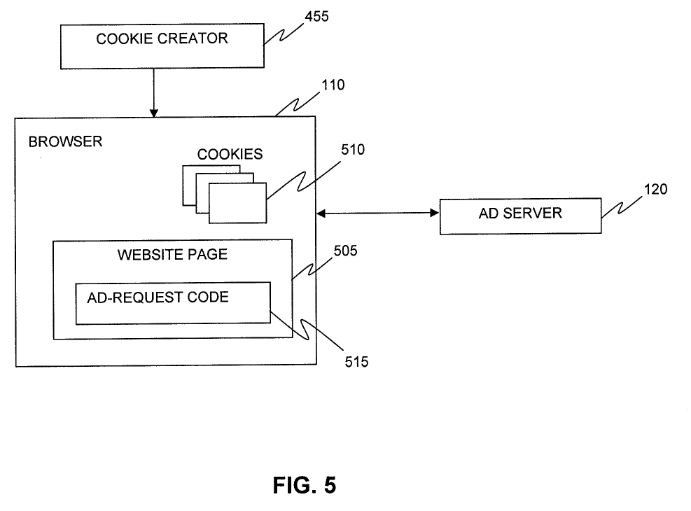

Referring now to FIG. 1, a block diagram of an exemplary environment for displaying commercial content within or alongside the application on the computing device is shown in accordance with various embodiments of the present invention. A user can use a Computing Device 105 for various tasks, such as browsing websites on a Browser 110, searching the Internet, sending and receiving emails, chatting, documentation, downloading from or uploading to the World Wide Web (WWW), etc. A method and a system 115 of the present invention enables determining one or more user interest topics, based on a browsing history of the user. System 115 uses the one or more user interest topics to fetch the commercial content from an Ad Server 120. The commercial content can be displayed within or alongside an Application 125 on Computing Device 105. Application 125 can be any application, including, but not limited to, Browser 110 or offline applications. System 115 may be installed on Computing Device 105. Alternately, some or all of the system elements, described in conjunction with FIG. 4 and FIG. 5, can be installed independently, for example on Ad Sever 120 or on an independent server.

For instance, if a user browses a cars related website on Browser 110, System 115 determines that the user may be interested in cars and car-related information. In accordance with the present invention, System 115 communicates with Ad Sever 120 to fetch the commercial content which is relevant to cars. The commercial content may be, but not limited to, advertisements of car companies, latest car races, etc. The commercial content can then be displayed on Application 125 on Computing Device 105. Application 125 can be Browser 110 itself, or other applications such as a media player, an email client etc.

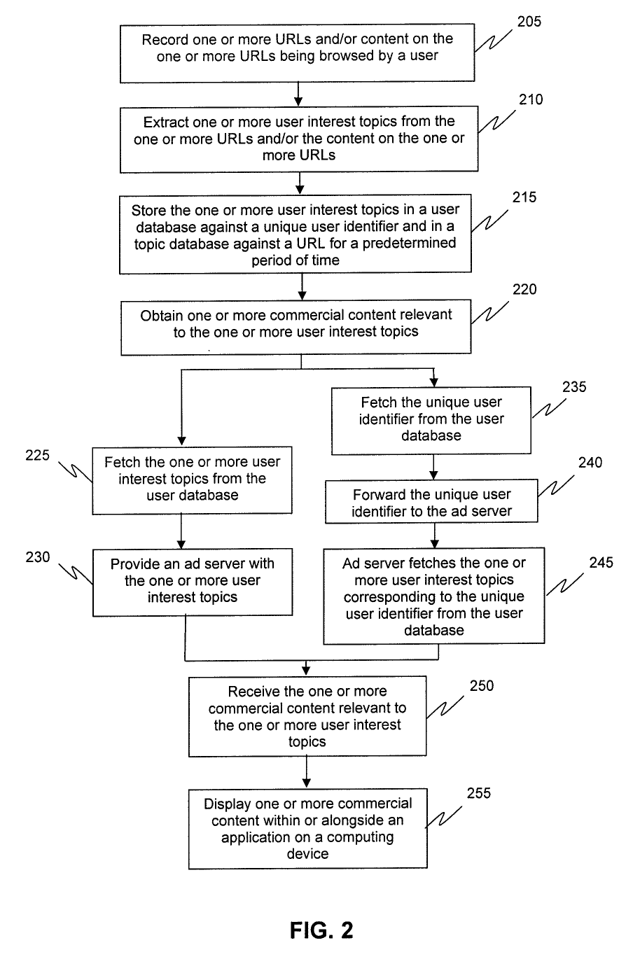

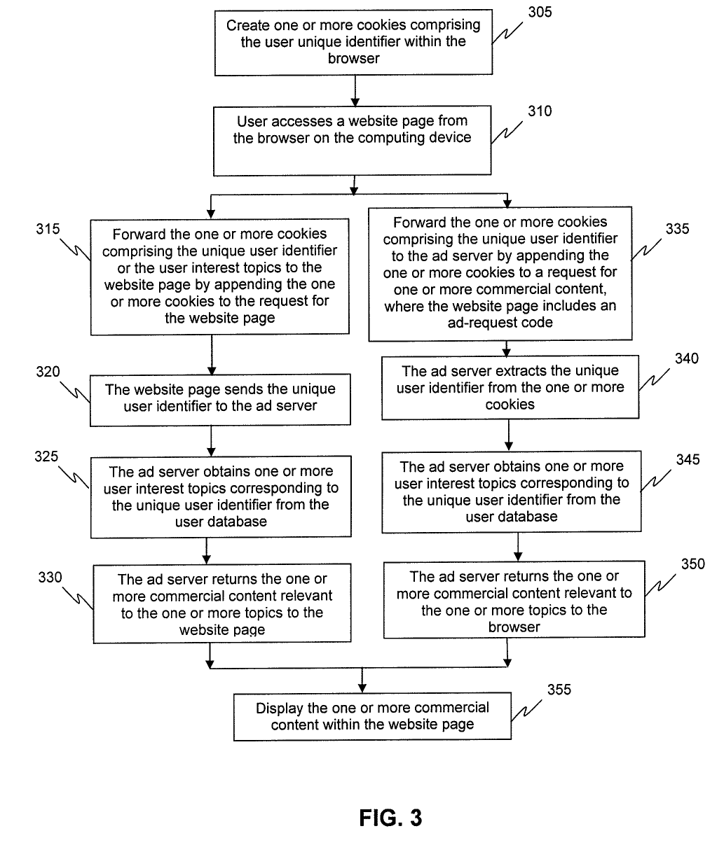

The method of displaying the commercial content on Application 125 is described below in conjunction with FIG. 2 and FIG. 3. Further, System 115 for displaying the commercial content on Application 125 is described below in conjunction with FIG. 4 and FIG. 5.

Turning now to FIG. 2, a flow diagram of a method for displaying the commercial content within or alongside Application 125 or Browser 110 on Computing Device 105 is shown in accordance with an embodiment of the present invention. A user browses the Internet on Browser 110, and one or more of URLs and the content on the URLs that the user browses is recorded at step 205. The recording can be done by one or more of Browser 110, a browser plugin on Browser 110, a parsing program parsing temporary internet files and browser cache of Browser 110. The URLs can include URLs of a website being browsed by the user or search engine URLs. URL strings of the URLs can include one or more of a domain name, a URL path, request parameters, etc. A plurality of temporary internet files or a browser cache of Browser 110 can be parsed for recording the URLs or the content on the URLs.

One or more user interest topics are extracted, at step 210, from one or more of the URLs and the content on the URLs. For instance, if the user accesses a website “http://www.computers.com/laptops”, the user interest topic of “laptops” and “computers” can be extracted from the URL of the website. Additional user interest topics can also be extracted from any query string parameters within the URL. For e.g. if the URL is a search engine URL, the user interest topic can be extracted using keywords searched by the user. The searched keywords are passed as request parameters in the resulting URL. For instance, if the user searches for laptops in a search engine, the search engine URL maybe of the form “www.searchengine.com/?q=laptop/”. From this URL, a user interest topic of “laptop” may be extracted at step 210.

Further, the user interest topics can also be extracted from the content on the URLs. The content can be extracted while the user is accessing the website or obtained from the browser history, or alternately, an independent request can be made to fetch the content on the URLs recorded.

In an embodiment of the present invention, the user interest topics for a given URL are extracted at step 210, only if the user interest topics have not already been extracted for the given URL earlier. Those skilled in the art will appreciate that this embodiment minimizes redundancy and consumption of resources.

The user interest topics are then stored, at step 215, in a topic database against the URL from which the user interest topics are extracted. For instance, in the example above, the user interest topics “laptop” and “computer” are stored in the topic database against the URL http://www.computers.com/laptops/. The user interest topics may not be extracted at step 210, if the user interest topics for a URL are already available in the topic database.

Also, the user interest topics can be stored, at step 215, in a user database against a unique user identifier. In the above example, the user interest topic of “laptops” and “computers” can be additionally stored in the user database against a unique user identifier of the user who was browsing http://www.computers.com/laptops/. The unique user identifier can be a generated alphanumeric string assigned to the user. The alphanumeric string can be such that it is independent of an identity of the user, so as to protect the identity of the user.

In an embodiment of the present invention, the topic database and the user database are stored in a temporary memory, for example the Random Access Memory (RAM), of Computing Device 105.

A unique user identifier can be created for each user of Computing Device 105. The user interest topics of different users are stored against their respective unique user identifiers in the user database, resulting in association of the correct user interest topics for all the users of Computing Device 105.

In an embodiment of the present invention, a user can request for creation of a new unique user identifier for the user. Further, part or all of the contents of the user database can be reset in response to a predetermined action. The predetermined action can be restarting Computing Device 105. This ensures that if a new user logs on, the user database contains user interest topics extracted from URLs accessed only by the new user. Similarly, the predetermined action can be restarting Browser 110. Alternately, the predetermined action can be a user action such as the user clicking on a reset button. Those skilled in the art will realize that resetting the user database can include, for instance, creation of a new unique user identifier, clearing the user database, clearing the user interest topics for a particular user, etc.

For instance, if a first user browses a laptop related URL, the extracted user interest topic is “laptops”. This user interest topic is stored against the first user's unique user identifier. If the first user logs off from Computing Device 105 and a second user logs on, a separate unique user identifier can be created or used for the second user. When the second user browses a cars related website, because of a different unique user identifier being created for the second user, commercial content related to ‘laptops’ will not be displayed on Application 125. Instead, cars related commercial content can be displayed to the second user. Hence, the present invention ensures that the commercial content is always relevant to a user currently using Computing Device 105.

In an embodiment of the present invention, the user database and the topic database are two different databases. In another embodiment of the present invention, the user database and the topic database are part of a relational database. In yet another database, the user database and the topic database are included in one single database. The topic database and the user database maybe in the form of a Relational Database or a temporary cache or an in-memory database, or a file, or any such storage form.

When the user uses Application 125 which wishes to display commercial content to the user, commercial content relevant to the user interest topics are obtained at step 220. In an embodiment, the commercial content can also be obtained and saved on Computing Device 105 beforehand, prior to the user starting Application 125. This ensures that the commercial content is available even when Computing Device 105 is offline.

A date and time when the user accesses a particular URL can be stored, at step 215, against the user interest topic extracted from that URL and against the user's unique user identifier in the user database. A user may use Computing Device 105 to search for laptops and then another user may use the same computing device, Computing Device 105, a few hours later and perform searches for cars. To ensure that laptops related commercial content is displayed to the first user and cars related commercial content to the second one, the user interest topics with a date and time greater than a predetermined date and time are used to obtain the commercial content at step 220 and following. The predetermined date and time can be the start-time of Computing Device 105, Application 125 or Browser 110.

In one embodiment, for obtaining the commercial content at step 220, the user interest topics are fetched from the user database at step 225 and the user interest topics are then provided to Ad Server 120 at step 230.

In an alternate embodiment, for obtaining the commercial content at step 220, the unique user identifier of the user is fetched from the user database at step 235 and is forwarded to Ad Server 120 at step 240. Ad Server 120 can then communicate with the user database to fetch the user interest topics corresponding to the unique user identifier at step 245.

Ad Server 120, upon receiving the user interest topics, returns the commercial content relevant to the user interest topics to Computing Device 105. Methods used for selecting commercial content relevant to a particular concept is known in the art and Ad Server 120 using any and all such methods to select the commercial content is within the scope of the present invention.

The commercial content relevant to the user interest topics is received at step 250. This commercial content can then be displayed within or alongside Application 125 at step 255. As mentioned earlier, Application 125 can be any application on Computing Device 105 or an application served on Computing Device 105 through Browser 110.

Turning now to FIG. 3, a flow diagram of a method for displaying the commercial content within a website page being browsed by the user on Computing Device 105 is shown in accordance with an embodiment of the present invention. An embodiment of the present invention, described in FIG. 3, enables display of relevant commercial content within a website page. This can be achieved by sending the user unique identifier or the user interest topics to the website page or by sending the user unique identifier or the user interest topics to Ad Server 120 which returns an ad block to be displayed directly within the website page. In this embodiment, Application 125 can be considered to be Browser 110, the website page, or a combination of Browser 110 along with the website page being browsed.

The sending of the user unique identifier or the user interest topics to the website page can be achieved through modifying the behavior of Browser 110 such that Browser 110 sends this information to the website page as a part of the request, or through creating cookies, which include one or more of the unique user identifiers or user interest topics, within the cookie folder of Browser 110 at step 305. The user accesses the website page on Browser 110 at step 310.

In one embodiment, Browser 110 forwards the cookie described above directly to the website page at step 315. The website page can be any website page. In this embodiment, separate cookies maybe created for various Top Level Domains (TLDs) by setting a cookie's domain to the TLD. For instance, separate cookies can be created for domain names with “com”, “net”, “org” etc. TLDs. So if the website page is has a “com” TLD, a cookie for “com” TLD is forwarded to the website page at step 315.

The website page sends either one of the unique user identifier and the user interest topics to Ad Server 120 at step 320. Ad Server 120 can obtain the user interest topics corresponding to the unique user identifier from the user database at step 325. Ad Server 120, finally, returns commercial content relevant to the user interest topics to the website page. The website page can then display the commercial content within the website page at step 355.

In an alternate embodiment, the cookies are created such that the cookie domain is specific to various ad servers. Hence, one or more cookies are created for one or more ad servers.

The website page, in this embodiment, includes an ad-request code. When the user accesses the website page, the ad-request code on the website page results in Browser 110 forwarding the cookie to its corresponding Ad Server 120 at step 335 along with a request for commercial content. Ad Server 120 extracts the unique user identifier or the user interest topics from the cookie at step 340. Ad Server 120 obtains the user interest topics corresponding to the unique user identifier from the user database at step 345. Upon receiving the user interest topics, Ad Server 120 returns the relevant commercial content to Browser 110 at step 350. Browser 110, then, displays the commercial content within the website page at step 355.

Those skilled in the art will appreciate that an advertiser may pay a publisher, for example an application provider of Application 125 or a browser provider of Browser 110, based on various pay models known in the art. For example, pay per click, pay per thousand impressions, pay per lead, pay per action etc. To minimize click spam or click fraud, an embodiment of the present invention includes verifying an authenticity of a request for the commercial content. The authenticity of a request can be determined based on the unique user identifier. Since a unique user identifier is created for each user, click spam or click fraud can be detected more easily than in conventional methods that use the user's Internet Protocol (IP) address to detect where a click is coming from.

Further, Ad Server 120 can reject a request for commercial content, if a number of requests coming from Application 125 or the website page for a specific unique user identifier exceeds a predetermined number of requests. For instance, the maximum number of requests coming from a same application or website page for a particular unique user identifier may be set to 10. If the number of requests exceeds 10, Ad Server 120 can reject these requests. This ensures that an advertiser does not pay for fraudulent clicks.

In an embodiment, a functionality of Application 125 is compromised or reduced, or an alternate version of the application is provided to the user, if Application 125 fails to find the unique user identifier or the user interest topics or both. For instance, if an email client does not find the unique user identifier and, consequently, cannot display the commercial content, the present invention can enable the email client to be operated only in a lite version, where certain functions of the email client are disabled. Alternately, a user can be given the permission to allow commercial content to be display on applications on Computing Device 105. If the user allows the display of commercial content, applications can be upgraded to premium version, which can include certain ad-on functions.

Turning now to FIG. 4, a block diagram of System 115 for displaying the commercial content within or alongside Application 125 or Browser 110 on Computing Device 105 is shown in accordance with an embodiment of the present invention. The user browses the Internet on Browser 110, and a Recording Module 405 records the URLs or content on the URLs being browsed by the user. Recording Module 405 can be Browser 110, a browser plugin on Browser 110, a parsing program parsing temporary internet files and/or browser cache of Browser 110. In an embodiment, Recording Module 405 can include a First Proxy Module 410. First Proxy Module 410 is configured such that the http traffic on Computing Device 105 passes through it, for recording the URLs or content on the URLs accessed by the user. First Proxy Module 410 can be installed on Computing Device 105 or on an independent server. The independent server can be an internet gateway. The method used by Recording Module 405 for recording the URLs or the content on the URLs or both is described in detail in conjunction with FIG. 2.

System 115 further includes a Topic Extractor 415. Topic Extractor 415 extracts user interest topics from the recorded URLs or the content on the URLs or both. In an embodiment, Topic Extractor 415 is configured to extract the user interest topics from the URLs only if those user interest topics are absent in a Topic Database 420. The method used by Topic Extractor 415 for extracting the user interest topics is described in detail in conjunction with FIG. 2. Topic Extractor 415 can be operatively coupled to Computing Device 105 or to an independent server.

Topic Database 420 is configured to store the user interest topics against a URL, from which the user interest topics are extracted. For instance, if the user accesses a laptop related URL, “http://www.computers.com/laptops”, Topic Extractor 415 extracts user interest topic as “laptops” and “computers”. “laptops” and “computers” are then stored as a user interest topic in Topic Database 420 against the URL “http://www.computers.com/laptops”. Additional user interest topics can also be extracted from any query string parameters within the URL.

Further, Topic Database 420 can store the user interest topics for a predetermined period of time. Those skilled in the art will appreciate that the predetermined period of time can be, but is not included to, a time till Computing Device 105 is restarted, a time till content on the URL is updated, Browser 110 is restarted, user requests clearing of Topic Database 420, etc. In an embodiment, the Topic Database 420 may be stored on a temporary memory, for example the RAM, of Computing Device 105. In an embodiment, Topic Database 420 may be permanent.

The user interest topics can also be stored in a User Database 425, against a unique user identifier. For instance, the user interest topics of “laptops” and “computers” in the previous example can be stored in User Database 425 against a unique user identifier of the user. The unique user identifier can be a generated alphanumeric string assigned to the user. The alphanumeric string can be such that it is independent of an identity of the user, so as to protect the identity of the user. The user interest topics can be stored in User Database 425 for a predetermined period of time. In an embodiment of the present invention, User Database 425 can be stored in a temporary memory, such as RAM, of Computing Device 105.

As mentioned in conjunction with FIG. 2, a unique user identifier can be created for each user of Computing Device 105. System 115 includes a Unique User Identifier Module 430 for creating different unique user identifiers for each user of Computing Device 105. The user interest topics of different users are stored against their respective unique user identifiers in User Database 425, resulting in association of the correct user interest topics for all the users of Computing Device 105.

In an embodiment of the present invention, a user can request Unique User Identifier Module 430 to create a new unique user identifier for the user. Further, to avoid displaying commercial content relevant to a previous user, but not the current user of Computing Device 105, part or all of the contents of User Database 425 can be reset in response to a predetermined action. The predetermined action can be restarting Computing Device 105. This ensures that if a new user logs on, User Database 425 contains the user interest topics extracted from URLs accessed only by the new user. Similarly, the predetermined action can be restarting Browser 110. Alternately, the predetermined action can be a user action such as the user clicking on a reset button. Those skilled in the art will realize that resetting User Database 425 can include, for instance, creation of a new unique user identifier, clearing User Database 425, clearing the user interest topics for a particular user, etc.

In an embodiment of the present invention, Topic Database 420 and/or User Database 425 can be configured to store a date and time when the user accesses a particular URL against the user interest topic extracted from that URL and against the user's unique user identifier. A user may use Computing Device 105 to search for laptops and then another user may use the same computing device, Computing Device 105, a few hours later and perform searches for cars. To ensure that laptops related commercial content is displayed to the first user and cars related commercial content to the second one, the user interest topics with a date and time greater than a predetermined date and time are used to obtain the commercial content at step 220 and following. The predetermined date and time can be the start-time of Computing Device 105, Application 125 or Browser 110.

In an embodiment of the present invention, Topic Database 420 and User Database 425 are two different databases. In another embodiment of the present invention, User Database 425 and Topic Database 420 are part of a relational database. In yet another database, User Database 425 and Topic Database 420 are included in one single database.

Topic Database 420 and User Database 425 maybe in the form of a Relational Database or a temporary cache or an in-memory database, or a file, or any such storage form.

Topic Database 420 and User Database 425 can be operatively coupled to Computing Device 105 or an independent server. The independent server can be, but is not limited to, an Internet Service Provider (ISP) server, and internet gateway, or any such server.

When the user uses Application 125 which wishes to display commercial content to the user, a Content Fetcher 435 obtains commercial content relevant to the user interest topics from Ad Server 120. In an embodiment, Content Fetcher 435 can also obtain and save the commercial content on Computing Device 105 beforehand, prior to the user starting Application 125. This ensures that the commercial content is available even when Computing Device 105 is offline.

In one embodiment of the present invention, Content Fetcher 435 obtains the user interest topics from User Database 425 and then provides the user interest topics to Ad Server 120. Content Fetcher 435 can also provide Ad Server 120 with only the user interest topics extracted from URLs accessed by the user after the predetermined date and time.

In an alternate embodiment, Content Fetcher 435 can obtain the unique user identifier of the user from User Database 425 and forward the unique user identifier to Ad Server 120. Ad Server 120 can then communicate with User Database 425 to fetch the user interest topics corresponding to the unique user identifier.

Ad Server 120, upon receiving the user interest topics, returns the commercial content relevant to the user interest topics to Content Fetcher 435. Methods used for selecting commercial content relevant to a particular concept are known in the art and Ad Server 120 using any and all such methods to select the commercial content is within the scope of the present invention.

In yet another embodiment of the present invention, System 115 includes an Intermediate Proxy Module 440. In this embodiment, the request from Content Fetcher 435 to Ad Server 120 for the commercial content is intercepted by Intermediate Proxy Module 440. The request can include the unique user identifier or the user interest topics corresponding to the user. In response to the request, Intermediate Proxy Module 440 can fetch the user interest topics corresponding to the unique user identifier from User Database 425. Intermediate Proxy Module 440, then, appends the user interest topics to the request for the commercial content and sends the request to Ad Server 120. Hence, in this embodiment, Ad Server 120 may not be required to be configured for fetching the user interest topics corresponding to a unique user identifier.

Next, Ad Server 120, upon receiving the user interest topics, returns the commercial content relevant to the user interest topics to Content Fetcher 435. Methods used for selecting commercial content relevant to a particular concept are known in the art and Ad Server 120 using any and all such methods to select the commercial content is within the scope of the present invention.

A Display Module 445 is configured to display the commercial content received from Ad Server 120. Display Module 445 can display this commercial content within or alongside Application 125. As mentioned earlier, Application 125 can be any application on Computing Device 105 or an application served on Computing Device 105 through Browser 110.

System 115 can also be configured to display commercial content within a website page being browsed by the user on Browser 110. This can be achieved by sending the user unique identifier or the user interest topics to the website page or by sending the user unique identifier or the user interest topics to Ad Server 120 which returns an ad block to be displayed directly within the website page. In this case, Application 125 can be considered to be Browser 110, the website page, or a combination of Browser 110 along with the website page being browsed.

In an embodiment, the website page contains a tag at a location where the commercial content has to be displayed. In this embodiment, System 115 includes a Second Proxy Module 450 which fetches the user interest topics using the unique user identifier from User Database 425. Second Proxy Module 450, receives the commercial content relevant to the user interest topics from Ad Server 120. Second Proxy Module 450, then, replaces a tag in the website page with the commercial content. Second Proxy Module 450 can be any in-between proxy module between Computing Device 105 and the website page.

In another embodiment, System 115 includes a Cookie Creator 455 for creating cookies within Browser 110 for fetching commercial content. Functioning of Cookie Creator 455 is described in detail in conjunction with FIG. 5.

Further, as an add-on, System 115 can also include a Spam Detector 460. Spam Detector 460 is configured to verify the authenticity of a request for the commercial content to minimize click spam or click fraud. Spam Detector 460 can determine the authenticity of a request based on the unique user identifier. Since a unique user identifier is created for each user, click spam or click fraud can be detected more easily than in conventional methods that use the user's Internet Protocol (IP) address to detect where a click is coming from.

Further, Ad Server 120 can be configured to reject a request for commercial content, if a number of requests coming from Application 125 or the website page for a specific unique user identifier exceeds a predetermined number of requests. For instance, the maximum number of requests coming from a same application or website page for a particular unique user identifier may be set to 10. If the number of requests exceeds 10, Ad Server 120 can reject these requests. This ensures that an advertiser does not pay for fraudulent clicks.

In an embodiment of the present invention, System 115 is configured to prompt the user to install system modules, if Application 125 fails to find those System modules, the unique user identifier and/or the user interest topics. The System modules include one or more of Recording Module 405, Topic Extractor 415, Topic Database 420, User Database 425, Content Fetcher 435, Display Module 445, a browser plugin, a parsing program, a browser cache, First Proxy Module 410, an independent server, Unique User Identifier 430 module, Intermediate Proxy Module 440, Cookie Creator 455, the ad-request code on the website page, Second Proxy Module 450 and Spam Detector 460.

In an embodiment, System 115 is configured to launch an alternate version of Application 125, if Application 125 fails to find some system modules, the unique user identifier and/or the user interest topics. The alternate version of Application 125 can have reduced functionalities. For instance, if an email client does not find the unique user identifier and, consequently, cannot display the commercial content, the present invention can enable the email client to be operated only in a lite version, where certain functions of the email client are disabled. Alternately, a user can be given the permission to allow commercial content to be display on applications on Computing Device 105. If the user allows the display of commercial content, the relevant system modules can be installed and Application 125 can be upgraded to a premium version, which can include certain ad-on functions.

Turning now to FIG. 5, a block diagram for displaying the commercial content within a Website Page 505 being browsed by the user on Computing Device 105 is shown in accordance with an embodiment of the present invention. This embodiment enables System 115 to display relevant commercial content within Website Page 505. This can be achieved by sending the user unique identifier or the user interest topics to the website page or by sending the user unique identifier or the user interest topics to Ad Server 120 which returns an ad block to be displayed directly within the website page. In this embodiment, Application 125 can be considered to be Browser 110, Website Page 505, or a combination of Browser 110 along with Website Page 505 being browsed.

Cookie Creator 455 creates one or more Cookies 510, which include the unique user identifiers or the user interest topics, within the cookie folder of Browser 110. When the user accesses Website Page 505 on Browser 110, in one embodiment, Browser 110 forwards Cookies 510 directly to Website Page 505 as a part of the request for the commercial content. Website Page 505 can be any website page. In this embodiment, Cookie Creator 455 may create separate cookies for various Top Level Domains (TLDs) by setting a cookie's domain to the TLD. For instance, Cookie Creator 455 can create separate cookies for domain names with “com”, “net”, “org” etc. TLDs. So if Website Page 505 is has a “com” TLD, a cookie for “com” TLD is forwarded to Website Page 505.

Cookie 510 can be appended to a request for the website page. Website Page 505 sends either one of the unique user identifier and the user interest topics to Ad Server 120. Ad Server 120 can obtain the user interest topics corresponding to the unique user identifier from User Database 425. Ad Server 120, finally, returns commercial content relevant to the user interest topics to Website Page 505. Website Page 505 can then display the commercial content within Website Page 505.

In an alternate embodiment, Cookie Creator 455 Creates Cookies 510 specific to various ad servers. Hence, one or more cookies are created corresponding to one or more ad servers.

Website Page 505, in this embodiment, includes an Ad-request Code 515. When the user accesses Website Page 505, Ad-request Code 515 results in Browser 110 forwarding Cookies 510 to Ad Server 120 along with a request for commercial content. Ad Server 120 extracts the unique user identifier of the user interest topics from Cookies 510. Ad Server 120 then obtains the user interest topics corresponding to the unique user identifier from User Database 425. Upon receiving the user interest topics, Ad Server 120 returns the relevant commercial content to Browser 110. Browser 110, then, displays the commercial content within Website Page 505.

Various embodiments of the present invention allow applications, including offline applications and web applications, to display targeted commercial content, such as advertisements to its users without comprising on user privacy. Further, displaying targeted commercial content on the applications used by the user increases advertiser visibility and sales while providing users with the ability to obtain more meaningful content based on their needs.

The above mentioned advantages are merely exemplary and should not be restricted to the ones specified. Those skilled in the art shall appreciate that the advantages may be several and all such advantages are within the scope of the present invention.

What is claimed is:

1. A method of displaying one or more commercial content as at least one of within and alongside an application on a computing device, the method comprising:
recording at least one of one or more Uniform Resource Locations (URLs) and content on the one or more URLs, the one or more URLs being browsed by a user using a browser on the computing device;
extracting one or more user interest topics from the at least one of the one or more URLs and the content on the one or more of URLs;
storing the one or more user interest topics in a user database against a unique user identifier and in a topic database against a URL for a predetermined period of time, the URL belonging to the one or more URLs;
obtaining the one or more commercial content relevant to the one or more user interest topics, the obtaining step comprising one of:
providing an ad server with the one or more user interest topics;
forwarding the unique user identifier to the ad server, the ad server fetching the one or more user interest topics corresponding to the unique user identifier from the user database;
receiving the one or more commercial content relevant to the one or more user interest topics.

2. The method of claim 1, wherein the recording step comprises parsing at least one of a plurality of temporary internet files and a browser cache of a browser on the user computing device.

3. The method of claim 1, wherein the one or more use interest topics are extracted using a URL string of a URL, the URL string comprising one or more of a domain name, a URL path, and one or more request parameters, the URL belonging to the one or more URLs.

4. The method of claim 3, wherein if the URL is a search engine URL, the one or more user interest topics are extracted using one or more keywords searched by the user, the one or more keywords being included in the one or more request parameters of the URL.

5. The method of claim 1, wherein the one or more user interest topics are extracted using the content on the one or more URLs, wherein the content on the one or more URLs is obtained from one or more of a browser history of the browser and an independent request for the content on the one or more URLs.

6. The method of claim 1, wherein the extraction step comprises extracting the one or more user interest topics from the one or more URLs, if the one or more user interest topics are absent in the topic database.

7. The method of claim 1, wherein the storing step further comprises storing against the one or more user interest topics and the unique user identifier, a date and time corresponding to the user browsing the URL, the one or more user interest topics being extracted from the URL, the URL belonging to the one or more URLs.

8. The method of claim 1, wherein the unique user identifier is an alphanumeric string assigned to the user in the user database, the alphanumeric string being independent of an identity of the user.

9. The method of claim 1, wherein a plurality of unique user identifiers are associated to a plurality of users using the computing device.

10. The method of claim 1, wherein the user requests for creation of a new unique user identifier corresponding to the user.

11. The method of claim 1, wherein the user database is reset in response to a predetermined action, the predetermined action comprising one or more of the computing device being restarted, the browser being restarted and a user action.

12. The method of claim 1, wherein the providing step comprises providing the one or more user interest topics to the ad server, wherein a date and time corresponding to the user browsing the one or more URLs is greater than a predetermined date and time, the one or more user interest topics corresponding to the one or more URLs.

13. The method of claim 12, wherein the predetermined date and time corresponds to a start-time of at least one of the application and the browser.

14. The method of claim 1, wherein the application is at least one of an offline application and a web application.

15. The method of claim 1, wherein the providing step comprises fetching the one or more user interest topics from the user database.

16. The method of claim 1, wherein the forwarding step comprises fetching the unique user identifier from the user database.

17. The method of claim 1, wherein the application is at least one of the browser and a website page, wherein the website page is being accessed by the user through the browser.

18. The method of claim 17, wherein the obtaining step further comprises one of:
sending the unique user identifier to the website page being browsed from the browser; and
forwarding the one or more user interest topics to the website page being browsed from the browser.

19. The method of claim 18, wherein one or more cookies are crested within the browser, the one or more cookies comprising one or more of the user unique identifier and the one or more user interest topics, the unique user identifier and the one or more user interest topics corresponding to the user accessing the website page on the browser.

20. The method of claim 19, wherein the one or more cookies are created corresponding to one or more of:
one or more Top Level Domains (TLDs); and
one or more ad servers.

21. The method of claim 19, wherein the website page comprises an ad-request code, the ad-request code resulting in the browser forwarding the one or more cookies comprising the unique user identifier to the ad server, wherein the one or more cookies are appended to a request for the one or more commercial content.

22. The method of claim 1 further comprises verifying an authenticity of a request for the one or more commercial content based on the unique user identifier.

23. The method of claim 1, wherein the ad server rejects a request for the one or more commercial content, if a number of requests corresponding to the unique user identifier received from at least one of the application and the website page exceeds a predetermined number of requests.

24. The method of claim 1, wherein an alternate version of the application is launched, if the application fails to find one or more of the unique user identifier and the one or more user interest topics, wherein the alternate version of the application has a reduced functionality.

25. A system for displaying one or more commercial content as at least one of within and alongside an application on a computing device, the system comprising:
a recording module, the recording module configured to record at least one of one or more Uniform Resource Locations (URLs) and content on the one or more URLs, the URLs being browsed by a user using a browser on the computing device;
a topic extractor, the topic extractor configured to extract one or more user interest topics from the at least one of the one or more URLs and the content on the one or more URLs;
a topic database, the topic database configured to store the one or more user interest topics against a URL for a predetermined period of time, the URL belonging to the one or more URLs;
a user database, the user database configured to store the one or more user interest topics against a unique user identifier for a predetermined period of time;
a content fetcher, the content fetcher configured to obtain the one or more commercial content relevant to the one or more user interest topics by performing one or more of:
providing an ad server with the one or more user interest topics;
forwarding the unique user identifier to the ad server, the ad server fetching the one or more user interest topics corresponding to the unique user identifier from the user database; and
a display module, the display module configured to display the one or more commercial content as at least one of within and alongside the application on the computing device, the one or more commercial content being received from the ad server.

26. The system of claim 25, wherein the recording module is one or more of the browser, a browser plugin on the browser, a parsing program parsing at least one of a plurality of temporary internet files and a browser cache of the browser, and a first proxy module wherein a plurality of http traffic on the computing device is intercepted by the first proxy module, the first proxy module being installed on one or more of the computing device and an independent server.

27. The system of claim 26, wherein the independent server is an internet gateway.

28. The system of claim 25, wherein the topic extractor is further configured to extract the one or more user interest topics from the one or more URLs, if the one or more user interest topics are absent in the topic database.

29. The system of claim 25, wherein the topic extractor is operatively coupled to one or more of the user computing device and an independent server.

30. The system of claim 25, wherein the user database is further configured to store against the unique user identifier and one or more user interest topics, a date and time corresponding to the user browsing a URL, the one or more user interest topics being extracted from the URL, the URL belonging to the one or more URLs.

31. The system of claim 25, wherein one or more of the topic database and the user database is operatively coupled to one or more of the user computing device and an independent server.

32. The system of claim 31, wherein the independent server is one or more of an Internet Service Provider (ISP) server and an internet gateway.

33. The system of claim 25, wherein the user database is configured to reset in response to a predetermined action, the predetermined action comprising one or more of the computing device being restarted, the browser being restarted and a user action.

34. The system of claim 25 further comprises a unique user identifier module, wherein the unique user identifier module creates a plurality of unique user identifiers corresponding to a plurality of users using the computing device.

35. The system of claim 34, wherein the unique user identifier module is configured to create a new unique user identifier corresponding to the user, in response to a request from the user.

36. The system of claim 25, wherein for providing the one or more user interest topics to the ad server, the content fetcher is further configured to obtain the one or more user interest topics from the user database.

37. The system of claim 25, wherein for forwarding the unique user identifier to the ad server, the content fetcher is further configured to obtain the unique user identifier from the user database.

38. The system of claim 25, wherein an intermediate proxy module intercepts a request for the one or more commercial content from the content fetcher, wherein the intermediate proxy module is configured to:
fetch the one or more user interest topics from the user database;
append the one or more user interest topics to the request for the one or more commercial content; and
send the request for the one or more commercial content to the ad server.

39. The system of claim 38, wherein the intermediate proxy module fetches the one or more user interest topics using the unique user identifier.

40. The system of claim 25, wherein the content fetcher is operatively coupled to one or more of the browser and a website page, the website page being browsed by the user through the browser.

41. The system of claim 40, wherein a cookie creator creates one or more cookies within the browser, the one or more cookies comprising one or more of the user unique identifier and the one or more user interest topics, wherein the cookie creator creates the one or more cookies based on one or more of:
one or more Top Level Domains (TLDs); and
one or more ad servers.

42. The system of claim 41, wherein the website page comprises an ad-request code, the ad-request code resulting in the browser forwarding the one or more cookies comprising one or more of the unique user identifier and the one or more user interest topics to the ad server, wherein the one or more cookies are appended to a request for commercial content.

43. The system of claim 40 further comprises a second proxy module, wherein the second proxy module is configured to:
fetch the one or more user interest topics using the unique user identifier from the user database;
receive the one or more commercial content relevant to the one or more user interest topics from the ad server; and
replace a tag in the website page with the one or more commercial content, wherein the tag indicates a location in the website page for the display of the one or more commercial content.

44. The system of claim 25 further comprises a spam detector, the spam detector configured to verify an authenticity of a request for the one or more commercial content based on the unique user identifier.

45. The system of claim 25, wherein the ad server is configured to reject a request for the one or more commercial content, if a number of requests corresponding to the unique user identifier received from at least one of the content fetcher and the website page exceeds a predetermined number of requests.

46. The system of claim 25 is configured to prompt the user to install one or more system modules if the application fails to find one or more of the one or more system modules, the unique user identifier and the one or more user interest topics, wherein the one or more system modules comprises the recording module, the topic extractor, the topic database, the user database, the content fetcher, the display module, a browser plugin, a parsing program, a browser cache, a first proxy module, an independent server, a unique user identifier module, an intermediate proxy module, a cookie creator, an ad-request code on a website page, a second proxy module and a spam detector.

47. The system of claim 25 is configured to launch an alternate version of the application, if the application fails to find one or more of the one or more system modules, the unique user identifier and the one or more user interest topics, the alternate version of the application having a reduced functionality, wherein the one or more system modules comprises the recording module, the topic extractor, the topic database, the user database, the content fetcher, the display module, a browser plugin, a parsing program, a browser cache, a first proxy module, an independent server, a unique user identifier module, an intermediate proxy module, a cookie creator, an ad-request code on a website page, a second proxy module and a spam detector.
